(19) United States
(12) Patent Application Publication
(10) Pub. No.: US 2026/0317201 A1
(43) Pub. Date: Oct. 15, 2026

(54) METHOD OF CLEANING GROUNDWSTER OF POLLUTANTS, IN PARTICULAR ORGANIC POLLUTANTS

(71) Applicant: POLYCARBONPLUS GMBH, Buxtehude (DE)

(72) Inventors: Jairo Dario MELO PINEDA, Hamburg (DE); Herbert GERDAU, Haltern am See (DE)

(21) Appl. No.: 18/878,819

(22) PCT Filed: Jul. 6, 2023
(86) PCT No.: PCT/EP2023/068644

§ 371 Date: Jan. 30, 2025

(30) Foreign Application Priority Data
Jul. 8, 2022 (DE) 10 2022 117 051.9

(51) Int. Cl. C02F 1/28; B01J 20/34; C02F 101/32; C02F 101/36; C02F 103/06

(52) U.S. Cl. CPC C02F 1/285; B01J 20/3483; C02F 2101/32; C02F 2101/36; C02F 2103/06

(57) ABSTRACT

The invention relates to a method for cleaning groundwater (1a, 1b) contaminated by pollutants. The contaminated groundwater is brought into contact with an adsorption material (2). Pollutants or organic pollutants are adsorbed by the adsorption material. An adsorption material is used that comprises at least one polymer, in particular a rubber, and at least one filler, in particular carbon black.

### SPECIFICATION

The invention relates to a method for the purification of groundwater contaminated with pollutants, in particular with organic pollutants. In particular, “organic pollutants” are hydrocarbons and preferably halogenated hydrocarbons and/or cyclic hydrocarbons, in particular aromatic hydrocarbons.

Groundwater contaminated with pollutants constitutes a considerable environmental problem. Halogenated hydrocarbons, in particular chlorinated hydrocarbons, are used in various industrial or technical fields. For decades, the waste material involved was not disposed of properly, and so groundwater became contaminated with these toxins. An example of a specific problem is trichloroethylene (TCE) that is almost insoluble in water and is extremely difficult to remove when it contaminates groundwater.

Methods of the aforementioned type are known, in which the contaminated groundwater is pumped out of the ground onto the ground surface and then diluted to such an extent with water that it can be conducted to a further treatment, for example in wastewater treatment plants. This procedure has the disadvantage of requiring large quantities of water and complicated and energy-consuming pumping facilities in order to transport the considerable quantities of diluted groundwater to treatment sites that are usually further away. Any leaks during this transportation can in turn result in very disadvantageous consequences for the environment because the pollutants are released. In this regard, the known procedures are complicated, of low efficiency, expensive and hazardous.

In contrast, the technical problem to be solved by the invention is to provide a method of the aforementioned type with which pollutants or organic pollutants can be removed from contaminated groundwater in a simple, effective and cost-effective manner. Above all, it should also avoid placing further burdens on the environment.

In order to solve this technical problem, the invention teaches a method for the purification of groundwater contaminated with pollutants, in particular with organic pollutants, wherein the contaminated groundwater is brought into contact with an adsorption material, wherein pollutants or organic pollutants are adsorbed by the adsorption material, wherein an adsorption material is used that has at least one polymer, in particular at least one rubber, and at least one filler, in particular carbon black. In a particularly recommended embodiment of the invention, the adsorption material is produced from at least one polymer, in particular at least one rubber, in a finely divided form, and from at least one powdered filler, in particular powdered carbon black.

Within the context of the invention, the at least one polymer of the adsorption material is a rubber. In a particularly preferred embodiment of the invention, an adsorption material with at least one rubber from the “emulsion-styrene butadiene rubber (ESBR), styrene butadiene rubber (SBR), natural rubber” group is used. Preferably, a butadiene rubber is used. In the context of the method in accordance with the invention, the use of a food grade rubber is particularly recommended.

Again within the context of the invention, the adsorption material has at least one filler in the form of carbon black. In particular, the at least one carbon black is industrial carbon black or industrial black. Preferably, the at least one carbon black is industrial black. In a particularly preferred embodiment of the invention, the filler is at least one carbon black from the “furnace black, gas black, lamp black” group. In the context of the invention, the use of furnace black as the filler is particularly recommended. Preferably, a carbon black with an iodine absorption number of 20 to 400 mg/g, preferably of 40 to 300 mg/g, particularly preferably of 60 to 200 mg/g is used (measured in accordance with ASTM D 1510). Advantageously, a carbon black is used that has a BET specific surface area (NSA) of 10 to 800 m²/g, preferably of 30 to 500 m²/g, particularly preferably of 50 to 250 m²/g (measured in accordance with ASTM D 6556).

A highly recommended embodiment of the invention is characterized in that the adsorption material consists of at least 80% by weight, preferably at least 85% by weight and preferably at least 90% by weight of the at least one polymer, in particular of the at least one rubber and of the at least one filler or carbon black. The scope of the invention encompasses the adsorption material having further additives such as minerals and/or metal salts or the like. However, the main components of the adsorption material are the at least one polymer, in particular the at least one rubber, and the at least one filler, in particular the at least one carbon black.

More preferably, the scope of the invention encompasses an adsorption material that consists of 10 to 70% by weight, preferably 15 to 60% by weight, preferably 20 to 50% by weight, more preferably 30 to 50% by weight, particularly preferably 35 to 50% by weight, more particularly preferably 40 to 50% by weight, more preferably 45 to 50% by weight, for example 50% by weight or approximately 50% by weight, of the at least one polymer or of the at least one rubber. In a recommended embodiment of the invention, the weight ratio of polymer (preferably rubber) to filler (preferably carbon black) is 0.5:3 to 4.5:3 and preferably 0.75:3 to 3:3. The scope of the invention encompasses the feature that the filler or the carbon black is present in excess with respect to the polymer or the rubber. The scope of the invention also encompasses the possibility that the polymer or the rubber is in excess with respect to the filler or carbon black. It is additionally possible for the weight ratio of polymer (preferably rubber) to filler (preferably carbon black) to be 1:1 or approximately 1:1.

In principle, in the context of the method in accordance with the invention, the adsorption material may be used in different forms. Preferably, in the context of the method in accordance with the invention, a powdered adsorption material and/or an adsorption material in the form of pellets and/or granular particles may be used.

In principle, a plurality of organic pollutants or organic solvents can be removed from the contaminated groundwater with the method in accordance with the invention. The underlying concept of the invention is that above all, the method is suitable for the purification or for the selective purification of severely contaminated groundwater. In this regard, “severely contaminated groundwater” in particular means groundwater that is contaminated with organic pollutants that are not dissolved in the groundwater and/or with pollutants containing bulky molecules. The method in accordance with the invention has been shown to be particularly suitable for removing organic pollutants in the form of halogenated hydrocarbons, in particular in the form of chlorinated hydrocarbons, and/or in the form of cyclic hydrocarbons, in particular aromatic hydrocarbons, from the contaminated groundwater. In the context of the method in accordance with the invention, the removal of halogenated hydrocarbons, in particular of chlorinated hydrocarbons, from the contaminated groundwater is of particular significance. Here, the method in accordance with the invention has been shown to be particularly effective. The removal of trichloroethylene (TCE) from the contaminated groundwater is of more particular significance in this regard. Surprisingly, TCE can be selectively and effectively removed from the contaminated groundwater with the method in accordance with the invention. Thus, surprisingly, the adsorption material can absorb 8 to 10 times its own weight of TCE. The context of the invention encompasses the feature that with the adsorption material, organic pollutants that are not dissolved in the contaminated groundwater, preferably halogenated hydrocarbons, preferably chlorinated hydrocarbons, can in particular be removed from the contaminated groundwater. Such undissolved organic pollutants, in particular halogenated hydrocarbons, have until now given rise to the biggest problems.

The underlying concept of the invention is that the removal of the organic pollutants, in particular the halogenated hydrocarbons, from the contaminated groundwater takes place in accordance with a particular mechanism. Firstly, in a first step, the organic pollutants are adsorbed by the adsorption material. It is considered that the particles of pollutant become deposited in the pore structure of the adsorption material and that swelling of the adsorption material takes place. The particles of pollutant are thereby efficiently imprisoned in the adsorption material and therefore preferably also absorbed by the adsorption material. This mechanism is particularly effective in the case of halogenated hydrocarbons and above all in the case of TCE. In principle, however, other organic pollutants, in particular aromatic hydrocarbons, can be efficiently removed from the contaminated groundwater. This is especially the case for organic pollutants that are not dissolved in the groundwater. The adsorption material employed in accordance with the invention is advantageously a hydrophobic adsorption material. Preferably, in addition, the at least one polymer, in particular the at least one rubber, forms a polymer framework or a matrix and particularly preferably, the polymer framework or the matrix is filled with the at least one filler, in particular with the carbon black.

A particularly significant embodiment in the context of the method in accordance with the invention is characterized in that the adsorption material loaded with the pollutants is regenerated. Preferably in this regard, the regeneration is carried out thermally and particularly preferably by stripping. In this regard, the adsorption material loaded with pollutants is heated, for example to 90° C. to 110° C. In a preferred embodiment, when the regeneration is carried out by stripping, advantageously, a hot gas, in particular hot air, is used as the stripping agent or stripping gas. The underlying concept of the invention is that the adsorption material loaded with the pollutants from severely contaminated groundwater in particular can be regenerated in an effective manner. This is especially the case with adsorption material loaded with halogenated hydrocarbons, in particular with TCE. The scope of the invention encompasses the feature that the adsorption material, after the preferred regeneration, can be returned to its intended use in accordance with the invention or can be used for the further purification of contaminated groundwater. Although the pollutants, in particular the halogenated hydrocarbons, are very effectively bound into the adsorption material after purification of the contaminated groundwater, nevertheless, a simple regeneration can take place that, surprisingly, functions particularly effectively in the case of halogenated hydrocarbons and in particular with TCE.

Preferred alternatives to the method in accordance with the invention will be described below. In a first embodiment of the method in accordance with the invention, contaminated groundwater is pumped out of the ground to the ground surface and is brought into contact with the adsorption material on the ground surface or above the ground surface in order to absorb the pollutants. In this regard, the scope of the invention encompasses the feature that at least one adsorption container is filled with the adsorption material and that the contaminated groundwater is conducted through this adsorption container or through the adsorption material. In accordance with a recommended embodiment, a plurality of adsorption containers filled with the adsorption material are connected one behind the other and the contaminated groundwater is passed through them. In this regard, the scope of the invention encompasses the feature that the groundwater here is purified to the extent that the pollutants contained therein are below prescribed or prespecified threshold values. The scope of the invention encompasses the feature that undissolved organic pollutants and/or bulky pollutant molecules contained in severely contaminated groundwater in particular can be removed or selectively removed with the at least one adsorption container. Advantageously, in a further step of the method, the pollutants contained in lightly contaminated groundwater, preferably in at least one separate purification container, can be removed from the groundwater. The scope of the invention encompasses the feature that the purification containers are filled with the adsorption material used in accordance with the invention. In addition or as an alternative, however, other purification substances, perhaps activated carbon, may also be used in the purification containers. “Lightly contaminated groundwater” in particular means groundwater that is contaminated with organic pollutants and/or with pollutants with less bulky molecules dissolved in the groundwater. The scope of the invention encompasses the feature that the groundwater is purified to an extent such that the pollutants contained therein are below prescribed or prespecified threshold values. The groundwater purified with this first procedure in accordance with the invention can then be returned to the ground.

In accordance with another procedure in accordance with the invention, the adsorption material is injected or pumped into the ground and is brought into contact with the contaminated groundwater in order to absorb the pollutants below the ground surface, and then the adsorption material loaded with the pollutants is transferred or pumped to the ground surface. Advantageously, the adsorption material in this procedure is introduced into the ground as a suspension or in the form of an aqueous suspension.

In the context of the procedure described above, a second embodiment of the method in accordance with the invention is characterized in that the contaminated groundwater is initially guided through the adsorption material that has been injected into the ground. In this regard, the scope of the invention encompasses the feature that pollutants of the severely contaminated groundwater are absorbed by the adsorption material. It is recommended that the groundwater that has been prepurified or prefiltered in this manner is transferred to the ground surface for further purification and purified further there, for example in at least one purification container. As already mentioned above, the scope of the invention encompasses the feature that the adsorption material used in accordance with the invention and/or other purification substances as well, such as activated carbon, are used in the at least one purification container. The scope of the invention encompasses the feature that here, lightly contaminated groundwater that has been prepurified is transferred to the ground surface and in the case of the latter purification, the pollutants are removed from the lightly contaminated groundwater, in particular in at least one purification container. Preferably, the adsorption material loaded with the pollutants is transferred or pumped out of the ground to the ground surface, collected in at least one collecting container and preferably undergoes at least one further treatment procedure. A treatment procedure of this type may be the preferred regeneration of the adsorption material loaded with the pollutants. The groundwater that has been purified of dissolved pollutants in this manner can then advantageously be transferred back into the ground.

A third preferred alternative of the method in accordance with the invention is characterized in that the adsorption material is injected into the ground in at least one upstream stage of the method, brought into contact with the contaminated groundwater in order to adsorb the pollutants, and then the adsorption material loaded with the pollutants is transferred to the ground surface and preferably collected in at least one collecting container. In accordance with a recommended variational embodiment of this third alternative, at least two such stages of the method are implemented one after the other. In this regard, the scope of the invention encompasses the feature that the pollutants of the severely contaminated groundwater are removed. Advantageously, after this adsorption of the pollutants in accordance with the invention, in particular of the undissolved organic pollutants, in a further step of the invention, the remaining lightly contaminated groundwater is transferred or pumped to the ground surface and there it is freed from the remaining organic pollutants. This purification is advantageously carried out in at least one purification container. In this regard, in accordance with one embodiment, this is at least one purification container as described above. The groundwater purified of the pollutants in this manner may then be returned to the ground.

The underlying concept of the invention is that in the context of the method in accordance with the invention, groundwater contaminated with pollutants, in particular with organic pollutants, can be purified in a simple, efficient and cost-effective manner. This is especially the case for organic pollutants that are undissolved in the groundwater and in particular for halogenated hydrocarbons and/or cyclic hydrocarbons or aromatic hydrocarbons. In this regard, the groundwater can be purified to the threshold values for pollutants prescribed by the authorities without any problems. Compared with the procedural methods described at the beginning, the disadvantageous use of considerable quantities of water and a complicated, lengthy transport of the groundwater to be purified is dispensed with. The pollutants are absorbed by the adsorption material in a functionally reliable manner, so that further environmental damage can be avoided. The effectiveness of the method in accordance with the invention is also characterized in that the adsorption material can absorb several times or even multiple times its own weight of pollutants. In addition, the regeneration of the adsorption material and the inventive renewed use of the adsorption material is possible in a relatively problem-free manner. The aforementioned advantages are particularly pronounced when the pollutants are halogenated hydrocarbons or chlorinated hydrocarbons. This is especially the case for the adsorption of trichloroethylene (TCE). What is more, the adsorption material, in particular hydrophobic adsorption material, used in accordance with the invention is very resistant to acids, bases and salt solutions and so can also be used for many purposes in accordance with the invention without problems. As a result, the method in accordance with the invention is characterized by simplicity, efficiency, minimal outlay and cost-effectiveness.

The invention will now be described in more detail with the aid of the drawings, given solely by way of embodiments in which, in schematic form:

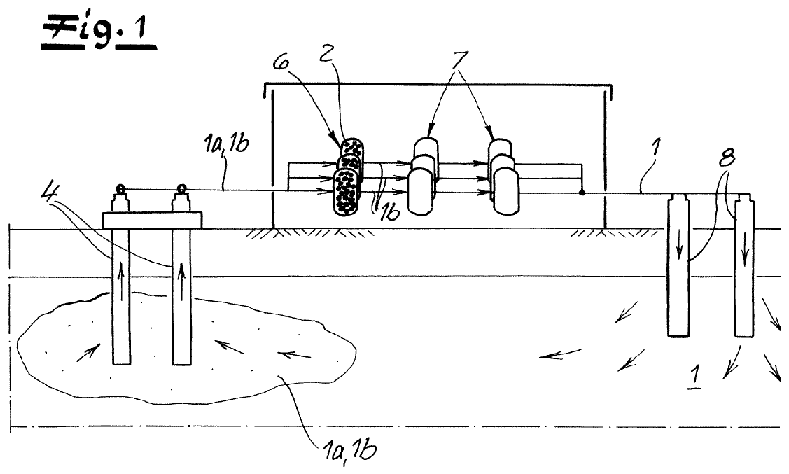

FIG. 1 shows a device for carrying out the method in accordance with the invention, in a first embodiment,

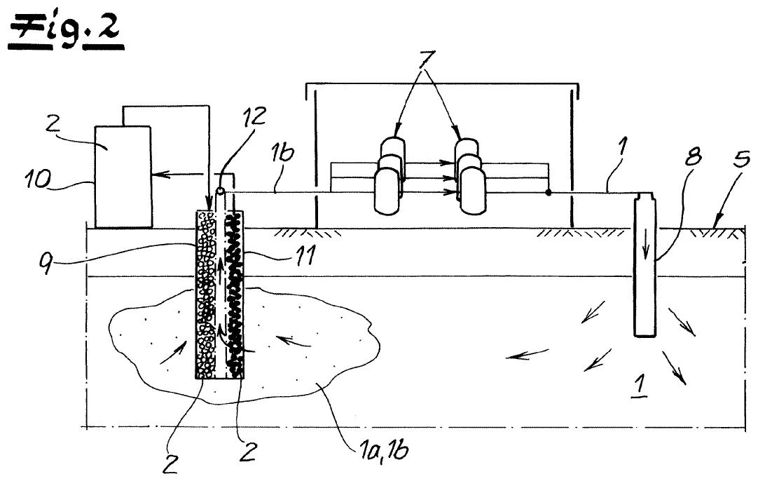

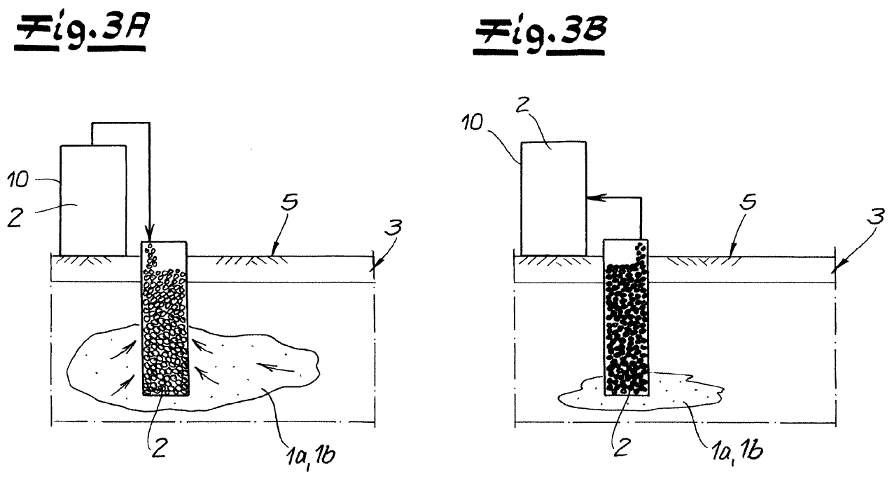

FIG. 2 shows the subject matter of FIG. 1 in a second embodiment, and

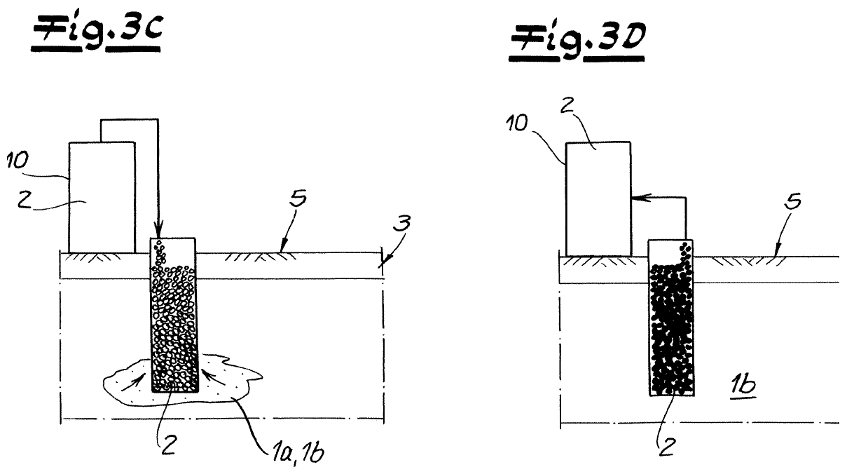

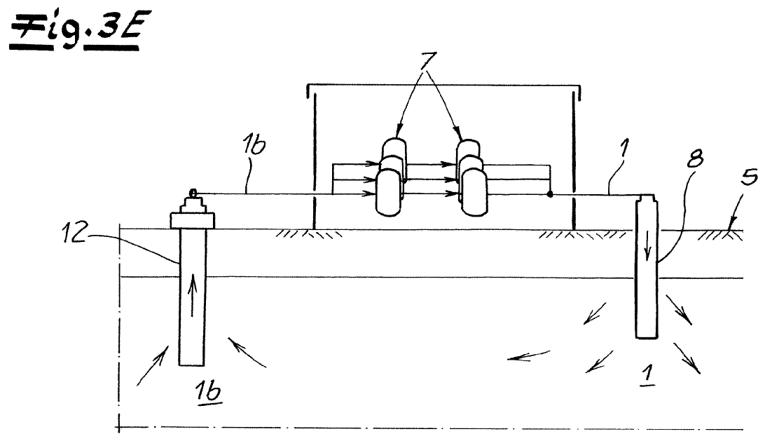

FIGS. 3A) to 3E show the subject matter of FIG. 1 in a third embodiment.

The drawing shows different embodiments of devices for carrying out the method in accordance with the invention for the purification of groundwater 1a, 1b contaminated with organic pollutants. The contaminated groundwater 1a, 1b is brought into contact with an adsorption material 2 used in accordance with the invention, whereupon organic pollutants are adsorbed by the adsorption material 2.

In the embodiment shown in FIG. 1, contaminated groundwater 1a, 1b is pumped out of the ground 3 to the ground surface 5 via at least one pump line 4. Two such pump lines 4 are shown in the embodiment of FIG. 1. Preferably and in the embodiment of FIG. 1, both severely contaminated groundwater 1a and lightly contaminated groundwater 1b is pumped to the ground surface 5. The severely contaminated groundwater 1a is contaminated with undissolved organic pollutants and/or with organic pollutants containing bulky molecules. In contrast, the lightly contaminated groundwater 1b is contaminated with dissolved organic pollutants and/or with less bulky molecules. The organic pollutants may in particular be organic solvents.

Preferably, and in the embodiment of FIG. 1, the contaminated groundwater 1a, 1b on the ground surface 5 is initially brought into contact with the adsorption material 2 used in accordance with the invention. Here, advantageously and in the embodiment, the adsorption material 2 is received in at least one adsorption container 6. In the embodiment of FIG. 1, three adsorption containers 6 are operated in parallel, for example. It is also possible to connect a plurality of adsorption containers 6 in series one behind the other. In such an adsorption container 6, the severely contaminated groundwater 1a is purified, in that the adsorption material 2 used in accordance with the invention selectively adsorbs or absorbs the undissolved organic pollutants and/or bulky molecules of organic pollutants. Advantageously and in the embodiment of FIG. 1, the lightly contaminated groundwater 1b that remains and that has been prepurified in this inventive manner is supplied to at least one purification container 7. Organic pollutants remaining in the groundwater 1b are removed from the lightly contaminated groundwater 1b in such a purification container 7. In the embodiment of FIG. 1, two purification stages are, for example, present for the lightly contaminated groundwater 1b, wherein respectively two purification containers 7 are connected in series one behind the other. In addition, in the embodiment of FIG. 1, three purification containers 7 are connected in parallel in each purification stage. The scope of the invention in principle encompasses the feature that the purification containers 7 are filled with the adsorption material 2. In addition or as an alternative, however, other purification substances, for example activated carbon, may be used in the purification containers 7. This is not shown in detail in the figures. The scope of the invention encompasses the feature that the groundwater 1a, 1b is purified, in that the pollutant content of the purified groundwater 1 is below the prescribed or prespecified threshold values. The purified groundwater 1 is returned to the ground 3 via at least one return line 8. In the embodiment of FIG. 1, two such return lines 8 are shown.

In the embodiment of FIG. 2, the adsorption material 2 used in accordance with the invention is injected into the ground 3 and brought into contact with the contaminated groundwater 1a, 1b in order to absorb the pollutants below the ground surface 5. The injection of the adsorption material 2 is advantageously carried out via at least one injection line 9. Next, the adsorption material 2 loaded with pollutants is pumped to the ground surface 5 and in the embodiment and there, it is advantageously transferred into at least one collecting container 10. In accordance with a preferred embodiment and in the embodiment, the contaminated groundwater 1a, 1b in the ground 3 is initially guided through the adsorption material 2 so that the pollutants of the severely contaminated groundwater 1a are absorbed by the adsorption material 2. Preferably, the adsorption material 2 here functions as a prefilter at the same time. The scope of the invention encompasses the feature that the lightly contaminated groundwater 1b guided through and prefiltered by the adsorption material is then pumped to the ground surface 5 for further purification. Advantageously and in the embodiment, the lightly contaminated groundwater 1b is transferred to the ground surface 5 at the same time as the adsorption material 2 loaded with pollutants. It is recommended that the preferred transfer of the loaded adsorption material 2 into the at least one collecting container 10 is carried out here via at least one collecting line 11. Preferably, the lightly contaminated groundwater 1b is transferred to the ground surface 5 via at least one discharge line 12. In the embodiment and as recommended, the lightly contaminated groundwater 1b is purified at the ground surface 5 in purification containers 7. Advantageously, as in the embodiment of FIG. 1, two purification stages are provided for the lightly contaminated groundwater 1b, wherein to this end, two purification containers 7 are connected in series. It should be pointed out that in each purification stage, a plurality of purification containers 7 can be operated in parallel. The scope of the invention encompasses the feature that groundwater 1 purified in the purification containers 7 is returned to the ground 3 via at least one return line 8. In accordance with one embodiment of the invention, the adsorption material 2 loaded with pollutants collected in the at least one collecting container 10 can be regenerated and returned to its intended use in accordance with the invention.

FIGS. 3A to 3E show individual steps of the method for a third embodiment of the method in accordance with the invention. In a first step of the method shown in FIG. 3A, the non-loaded adsorption material 2 is injected into the ground 3 and brought into contact with the contaminated groundwater 1a, 1b below the ground surface 5. Advantageously, in a second step of the method shown in FIG. 3B, the adsorption material 2 loaded with the pollutants of the severely contaminated groundwater 1a is then transferred to the ground surface 5 and preferably collected in a collecting container 10. The scope of the invention encompasses the feature that these two steps of the method according to FIGS. 3A and 3B relate to a prepurification of the severely contaminated groundwater 1a with the adsorption material 2. In this embodiment, severely contaminated groundwater 1a still remains in the ground 3. Preferably, and in a third step of the method shown in FIG. 3C, adsorption material 2 is then again introduced into the ground 3 and brought into contact with the contaminated groundwater 1a, 1b. In this step of the method, advantageously, the remaining pollutants of the severely contaminated groundwater 1a are absorbed by the adsorption material 2. In a step of the method shown in FIG. 3d), the adsorption material 2 loaded in this manner is transferred to the ground surface 5 and preferably collected in a collecting container 10. Finally, only lightly contaminated groundwater 1b remains in the ground 3 in this purified zone. Preferably, in a fifth step of the method shown in FIG. 3E, the lightly contaminated groundwater 1b is pumped to the ground surface 5 via at least one discharge line 12. Here, advantageously, the lightly contaminated groundwater 1b is then purified, and in fact preferably and as shown in the embodiment, in purification containers 7. This purification of the lightly contaminated groundwater 1b is basically carried out in an analogous manner to the alternatives of the method in accordance with the embodiment shown in FIGS. 1 and 2. The scope of the invention encompasses the feature that groundwater 1 purified in this manner is then returned to the ground 3 via at least one return line 8.

All of the alternative methods shown in FIGS. 1 to 3 are highly suitable for the purification of contaminated groundwater 1a, 1b, and in fact in particular for the purification of severely contaminated groundwater la. The organic pollutants and/or pollutants with bulky organic molecules that are undissolved in the groundwater 1 are selectively absorbed by the adsorption material 2 used in accordance with the invention. Above all, the procedures are suitable for removing halogenated hydrocarbons, in particular for removing chlorinated hydrocarbons, from the groundwater 1. The procedures in accordance with the invention are more particularly suitable for the removal of trichloroethylene (TCE) from the contaminated groundwater 1a, 1b.

In the alternative methods in accordance with FIGS. 1 to 3, the adsorption material 2 loaded with the pollutants of the severely contaminated groundwater 1a can be regenerated in a relatively problem-free manner, in particular thermally regenerated, and most preferably regenerated by stripping. Here too, the adsorption material 2 loaded with TCE is characterized by a particularly problem-free regeneration capability.

1. In a method for the purification of groundwater contaminated with pollutants, the improvement comprising the step of:
bringing the contaminated groundwater into contact with an adsorption material such that pollutants are adsorbed by the adsorption material, the adsorption material that containing a polymer and a filler.

2. The method according to claim 1, wherein the polymer is in a finely divided form and the filler is powdered.

3. The method according to claim 1, wherein the polymer is emulsion-styrene butadiene rubber, styrene butadiene rubber and/or natural rubber” group.

4. The method according to claim 1, wherein the filler is furnace black, gas black, and/or lamp.

5. The method according to claim 1, wherein the adsorption material consists of at least 80% by weight of a weight of the polymer and of the filler.

6. The method according to claim 1, wherein the adsorption material consists of 10 to 70% by weight.

7. The method according to claim 1, wherein the pollutants are halogenated hydrocarbons and are removed from the contaminated groundwater with the adsorption material.

8. The method according to claim 1, wherein organic pollutants are chlorinated hydrocarbons that are undissolved in the contaminated groundwater but that are removed from the contaminated groundwater with the adsorption material.

9. The method according to claim 1, wherein the pollutants include trichloroethylene that is removed from the contaminated groundwater with the adsorption material.

10. The method according to claim 1, further comprising the step of:
pumping the contaminated groundwater out of the ground to the ground surface and is brought into contact with the adsorption material on or above the ground surface in order to adsorb the pollutants.

11. The method according to claim 1, further comprising the step of:
injecting or pumping the adsorption material into the ground and thereby bringing the adsorption material into contact with the contaminated groundwater in order to adsorb the pollutants below the ground surface and
thereafter transferring or pumping the adsorption material loaded with the pollutants to the ground surface.

12. The method according to claim 1, further comprising the step of:
regenerating the adsorption material loaded with the pollutants is regenerated by stripping.
